(19) United States
(12) Patent Application Publication
(10) Pub. No.: US 2012/0223272 A1
(43) Pub. Date: Sep. 6, 2012

(54) INFRARED LIGHT-REFLECTING FILM AND PRODUCTION METHOD THEREOF

(75) Inventors: Wataru MAJIMA, Kanagawa (JP); Kazuhiro OKI, Kanagawa (JP)

(73) Assignee: FUJIFILM CORPORATION, Tokyo (JP)

(21) Appl. No.: 13/409,521

(22) Filed: Mar. 1, 2012

(30) Foreign Application Priority Data
Mar. 1, 2011 (JP) 2011-044276

(51) Int. Cl. C09K 19/00; B32B 37/02; B05D 3/06; B32B 37/14; B05D 5/06; B05D 3/02

(52) U.S. Cl. 252/299.7; 427/508; 427/517; 156/182

(57) ABSTRACT

A method of producing an infrared light-reflecting film includes a coating step of coating a polymerizable liquid crystal composition including a polymerizable cholesteric liquid crystal compound (A), a chiral agent having an HTP of 50 μm⁻¹ or less (B), a monofunctional monomer (C), and an organic solvent (D) on a substrate, an alignment step of aligning the polymerizable cholesteric liquid crystal compound by heating to form a cholesteric liquid crystal phase, and an irradiation step of irradiating the polymerizable liquid crystal composition with actinic radiation to fix the cholesteric liquid crystal phase and form an infrared light-reflecting layer, wherein the amount of a residual solvent after the alignment step is controlled to 0.20 g/m² or more.

### BACKGROUND OF THE INVENTION

1. Field of the Invention

The present invention relates to an infrared light-reflecting film that has a layer formed by fixing a cholesteric liquid crystal phase, and a production method thereof.

2. Description of the Related Art

With the recent increase of concern over and interest in the environment or energy, energy-saving industrial products have been increasingly demanded. For example, glass and films have been required which could effectively shield glass windows of houses or vehicles from heat, that is, effectively reduce the thermal load due to solar rays. In order to reduce the thermal load due to solar rays, it is necessary to prevent the transmission of some solar rays in the visible light region or the infrared light region in a solar light spectrum. Particularly, from the viewpoint of safety, high transmittance to the visible light region and heat-shielding performance are actively required for vehicle windows, and the reflectance of solar rays tends to be regulated in some countries.

Multi-layered glass coated with a special metal film blocking heat radiation, which is called low-E double glazing, is frequently used as eco-glass having high heat-insulating performance or high heat-shielding performance. The special metal film can be produced by laminating plural layers, for example, by the use of a vacuum film-forming method. The coating of the special metal film produced by the use of the vacuum film-forming method is excellent in reflection performance, but the vacuum process is low in productivity, whereby the production cost thereof is high. When a metal film is used, there is a problem, for example, in that electromagnetic waves are also shielded to cause radio interference when using mobile phones or the like, and in that when the metal film is used for vehicles, use of ETC (Electronic Toll Collection System) may be prevented. High transmittance of visible rays is required as well as resistance to the radio interference for vehicle windows in view of safety.

In this regard, a method using a cholesteric liquid crystal phase has been proposed. For example, JBP4109914B discloses a laminated optical film having a reflective circularly-polarizing plate formed thereon, which is arranged so as to allow penetration of the circularly polarized light in the same direction to both surfaces of a cholesteric liquid crystal phase.

Furthermore, JP2009-514022A (JP-H21-514022A) discloses an infrared light-reflecting article having a cholesteric liquid crystal phase. In addition, JP3500127B discloses an embodiment in which plural layers of the cholesteric liquid crystal phase are laminated in order to provide a use in a liquid crystal display device of reflecting light in the visible light region efficiently.

In laminating plural cholesteric liquid crystal phase layers, for example, a method of drying, heat-orienting, and UV-curing of a coating film containing a cholesteric liquid crystal material and repeating the above steps to laminate a cholesteric liquid crystal phase layer by layer on the previously formed cholesteric liquid crystal phase is used. Regarding the method of curing a cholesteric liquid crystal phase, a method of applying UV rays to a polymerizable liquid crystal is generally used, for example, as disclosed in JP4008358B. JP4008358B discloses a method of producing a cholesteric liquid crystal film of which the reflection wavelength band is wide by adjusting the illumination intensity in a predetermined range. JP3745221B discloses a method of producing a polarizer in which the wavelength region is continuous by setting the rotation directions of liquid crystal molecules in each of cholecteric liquid crystal phases to be identical at the time of laminating the cholesteric liquid crystal phases.

Furthermore, steps for coating and drying a liquid crystal material are disclosed in various documents. For example, JP2007-502911A discloses a method in which a liquid crystal composition including a cholesteric liquid crystal compound and 1,3-dioxolane is coated on a substrate and the initial drying condition is adjusted to form a cholesteric liquid crystal phase. JP2010-128270A discloses a method for producing an optical compensation film by adjusting the boiling point of an organic solvent, the phase transfer temperature of a liquid crystal compound, and the temperature in the temperature-raising and drying step. JP2010-128270A notes that it is preferable to reduce the amount of the residual solvent in a coating film to a range of 0.20 g/m² or less range before the step of aligning a liquid crystal compound. In JP2005-121827A, a phase difference plate having a uniform retardation is produced by using a solvent having a boiling point of 90° C. or higher and 250° C. or lower as a composition component.

### SUMMARY OF THE INVENTION

In order to produce a light-reflecting film having high heat-shielding performance, it is necessary to reduce the haze of a film and control the reflection wavelength band with a good precision. In order to reflect light at a long wavelength (in an infrared light region) by controlling the reflection wavelength band, a chiral agent is generally added, while adjusting the concentration, to a liquid crystal compound (for example, a rod-shaped liquid crystal compound) exhibiting a cholesteric liquid crystal phase, and the reflection band is adjusted. In this case, qualitatively, it is necessary to reduce the amount of the chiral agent added in order to shift the reflection wavelength to a long wavelength side (to the infrared light region).

Furthermore, in order to reduce the haze of a film, it is necessary to improve the alignment property of the cholesteric liquid crystal phase. This makes it possible to eliminate the alignment defects of the light-reflecting film and to adjust the haze to be lower.

HTP is generally used as an indicator indicating the performance of a chiral agent. HTP is an abbreviation of Helical Twisting Power and is a factor indicating the helically aligning ability expressed by Expression (1) below. Specifically, refer to “Study of Photosensitive Chiral Compounds for Cholesteric Liquid Crystals Directed toward the Color Filter for Liquid Crystal Display” (Masatoshi Yumoto and Mitsuyoshi Ichihashi, Fuji Film Research Report No. 50 (2005), pp. 60-63).

HTP=Refractive Index of Liquid Crystal/(Reflection Wavelength×Concentration of Chiral Agent) Expression (1)

Therefore, it is preferable to adjust the reflection wavelength using a small amount of a chiral agent having a high HTP in order to shift a reflection wavelength to a long wavelength side to reflect infrared light and to produce a light-reflecting film having a superior alignment property.

However, since no chiral agent causing left-handed twisting has a high HTP, it is inevitable at present to use a chiral agent having a low HTP. It is necessary to increase the amount of the chiral agent to be added so as to attain a desired reflection wavelength using such a chiral agent having a low HTP. As a result, the content of the impurities in the cholesteric liquid crystal phase is increased and the alignment property of the cholesteric liquid crystal is deteriorated, which causes a problem of an increase in the haze of the light-reflecting film.

In addition, in order to produce a cholesteric liquid crystal phase, it is also required to add a monofunctional monomer to improve the brittleness of a film. Similarly, in this case, the content of impurities in the cholesteric liquid crystal phase is increased and the alignment property of the cholesteric liquid crystal is deteriorated, which causes a problem of an increase in the haze of the light-reflecting film.

Therefore, it is strongly desired to produce an infrared light-reflecting film having excellent brittleness and a good haze even when a chiral agent having a low HTP is used.

It is an object to be attained by the invention to provide a method for producing an infrared light-reflecting film, by which an infrared light-reflecting film having excellent brittleness and a good haze even when a chiral agent having a low HTP is used can be obtained.

The present inventors have conducted extensive studies in order to solve the above-described problems, and as a result, they have found that the above-described problems can be solved by increasing the amount of the residual solvent under a specific condition in the step of aligning the liquid crystal compound even when using a chiral agent having a low HTP or monofunctional monomers, which may gives an adverse effect on the alignment of the liquid crystal, in contrast to the findings from JP2010-128270A.

The method of producing an infrared light-reflecting film of the invention obtained by solving the above-described problems includes a coating step of coating a polymerizable liquid crystal composition including a polymerizable cholesteric liquid crystal compound (A), a chiral agent having an HTP represented by the following Expression (1) of 50 μm⁻¹ or less (B), a monofunctional monomer (C), and an organic solvent (D) on a substrate, an alignment step of aligning the polymerizable cholesteric liquid crystal compound by heating to form a cholesteric liquid crystal phase, and an irradiation step of irradiating the polymerizable liquid crystal composition with actinic radiation to fix the cholesteric liquid crystal phase and form an infrared light-reflecting layer, wherein the amount of a residual solvent after the alignment step is controlled to 0.20 g/m² or more.

HTP=Refractive Index of Polymerizable Cholesteric Liquid Crystal Compound/{Selective Reflection Wavelength (unit: μm) of Cholesteric Liquid Crystal Phase×Mass ratio of Chiral Agent to Polymerizable Cholesteric Liquid Crystal Compound} Expression (1)

In a preferable embodiment of the invention, the organic solvent (D) includes at least two kinds of organic solvent, the organic solvent (D) includes an organic solvent having a boiling point of 150° C. or higher, the proportion of the organic solvent having a boiling point of 150° C. or higher to the total amount of the organic solvent (D) is not less than 3% by mass and not more than 30% by mass, or the organic solvent (D) is a compound having a hydrocarbon ring in the form of a 6- to 7-membered ring.

Furthermore, in a preferable embodiment of the invention, the monofunctional monomer (C) is a (meth)acrylate compound, the addition amount of the monofunctional monomer (C) with respect to the total mass of the polymerizable cholesteric liquid crystal compound (A) and the monofunctional monomer (C) in the polymerizable liquid crystal composition is from 2% by mass to 30% by mass, or the addition amount of chiral agent (B) with respect to the total mass of the polymerizable cholesteric liquid crystal compound (A) and the monofunctional monomer (C) in the polymerizable liquid crystal composition is from 1% by mass to 18% by mass.

Moreover, in a preferable embodiment of the invention, the HTP of the chiral agent (B) is 40 μm⁻¹ or less, but in a preferable embodiment, a photopolymerization initiator is added to the polymerizable liquid crystal composition, the infrared light-reflecting layer reflects infrared light at a wavelength of 800 nm or more, or the infrared light-reflecting layer reflects left-handed circularly polarized light.

Furthermore, in a preferable embodiment of the invention, a laminating step of laminating two or more infrared light-reflecting layers by repeating at least once a set of the coating step using the other kind of the polymerizable liquid crystal composition on the infrared light-reflecting layer, the alignment step, and the irradiation step is included, the infrared light-reflecting layer has at least one layer of each of a layer reflecting right-handed circularly polarized light and a layer reflecting left-handed circularly polarized light, at least one of the infrared light-reflecting layers reflects infrared light at a wavelength of 800 nm or more, or the substrate is a polyethylene terephthalate film.

In a preferable embodiment, the method of producing an infrared light-reflecting film of the invention is a method for producing an infrared light-reflecting film for window members of vehicles or window members of building structures.

In the invention, an infrared light-reflecting film produced by the method for producing an infrared light-reflecting film above is also included.

According to the invention, a method of producing an infrared light-reflecting film, by which an infrared light-reflecting film having excellent brittleness and a good haze can be obtained even when a chiral agent having a low HTP is used, can be provided.

### BRIEF DESCRIPTION OF THE DRAWINGS

FIG. 1 is a cross-sectional view schematically illustrating an example of the infrared light-reflecting film produced by a production method according to the invention.

FIG. 2 is a cross-sectional view schematically illustrating another example of the infrared light-reflecting film produced by the production method according to the invention.

### DESCRIPTION OF THE PREFERRED EMBODIMENTS

Hereinafter, the invention will be described in detail. The description of the constitution requirements below may be based on the representative embodiments of the invention, but the invention is not intended to be limited to such embodiments. Further, in the present specification, a range of numerical values represented using “to” means a range that includes the numerical values described before and after the “to” as a minimum value and a maximum value. In addition, in the present specification, the polymerizable group refers to a group which causes a polymerization reaction by irradiation with actinic radiation.

[Method of Producing Infrared Light-Reflecting Film]

The method for producing an infrared light-reflecting film of the invention includes a coating step of coating a polymerizable liquid crystal composition including a polymerizable cholesteric liquid crystal compound (A), a chiral agent having an HTP represented by the following Expression (1) of 50 μm⁻¹ or less (B), a monofunctional monomer (C), and an organic solvent (D) on a substrate, an alignment step of aligning the polymerizable cholesteric liquid crystal compound by heating to form a cholesteric liquid crystal phase, an irradiation step of irradiating the polymerizable liquid crystal composition with actinic radiation to fix the cholesteric liquid crystal phase and form an infrared light-reflecting layer, wherein the amount of the residual solvent after the alignment step is controlled to 0.20 g/m² or more. Herein, the HTP is a value represented by the following Expression (1). Further, the method of producing an infrared light-reflecting film of the invention may also be referred to the production method of the invention.

HTP=Refractive Index of Polymerizable Cholesteric Liquid Crystal Compound/{Selective Reflection Wavelength (unit: μm) of Cholesteric Liquid Crystal Phase×Mass ratio of Chiral Agent to Polymerizable Cholesteric Liquid Crystal Compound} Expression (1)

(HTP)

First, Expression (1) above will be described.

The helical alignment power of a chiral agent can be expressed by HTP (Helical Twisting Power). Here, the refractive index of a curable liquid crystal compound in Expression (1) means the following, for example, as described in page 20 of “Lightwave Engineering (Yasuo Kokubun, published by Kyoritsu Publishing Co. (1999)”.

Ratio of Phase Speed c in Vacuum to Phase Speed vₚ in Medium (which refers to a polymerizable cholesteric liquid crystal compound) n=c/vₚ [Equation 1]

The selective reflection wavelength of the cholesteric liquid crystal phase means a wavelength obtained by multiplying the average refractive index of the cholesteric liquid crystal molecules with the chiral pitch (helical pitch) of the cholesteric liquid crystal molecules. The mass ratio of the chiral agent to the polymerizable cholesteric liquid crystal compound means a ratio of solid mass (weight) of the chiral agent per unit/mass (weight) of the polymerizable cholesteric liquid crystal compound per unit. A higher HTP means a higher helically aligning ability, and is capable of allowing production of a film having a low haze, which is thus preferable. However, since no chiral agent causing left-handed twisting causes a high HTP, it is required at present to use a chiral agent having a low HTP. Accordingly, in the invention, a chiral agent having a low HTP is used.

The HTP of the chiral agent used in the invention is 50 μm⁻¹ or less, preferably 45 μm⁻¹ or less, and particularly preferably 40 μm⁻¹ or less. Further, the HTP of the chiral agent is preferably 10 μm⁻¹ or more, and more preferably 20 μm⁻¹ or more.

Here, the HTP of the chiral agent can be determined by experimentally acquiring the dependency of a selective wavelength on the chiral agent concentration and can be determined uniquely.

(Reflection Wavelength)

The production method of the invention relates to a method of producing an infrared light-reflecting film. By using the production method of the invention, an infrared light-reflecting film having excellent brittleness and a good haze can be obtained even when a chiral agent having a low HTP is used. Further, it is known that a wavelength in a specific region, that is reflected by the infrared light-reflecting film, can be shifted according to various factors of the production method. For example, the wavelength region that can be reflected may be shifted by adjusting the conditions such as the concentration of the chiral agent to be added, the temperature at which the cholesteric liquid crystal phase is fixed, the irradiance or the irradiation time, and the like. Further, the wavelength region that can be reflected as mentioned herein is the same as the selective reflection wavelength in the Expression (1).

The method for producing an infrared light-reflecting film of the invention can be preferably used in the case of production of an infrared light-reflecting film that reflects the infrared light at 800 nm or more.

The production method of the invention is accomplished by the finding that when using a chiral agent having a low HTP, and a monofunctional monomer so as to improve the brittleness, and further, when an infrared light-reflecting layer reflecting a wavelength in the long-wavelength infrared light region is used, the chiral agent or the monofunctional monomer gives an effect on the alignment of the liquid crystal and thus deteriorates the haze of a film. The production method of the invention can solve the above-described problems by controlling the amount of the residual solvent after the alignment step within a specific range.

The production method of the invention can be preferably used for production of an infrared light-reflecting film having a reflection center wavelength in 950 to 2000 nm, and more preferably used for production of an infrared light-reflecting film having a reflection center wavelength in 950 to 1400 nm. Further, the reflection center wavelength as mentioned herein is calculated by λ=n·pitch (in the formula, n represents an average refractive index of the liquid crystal, and the pitch represents the helical pitch (nm) of the cholesteric liquid crystal), but the half-width of the reflection spectrum may be simply referred to as a reflection center wavelength.

(Production Step)

Hereinbelow, the materials or steps that are preferably used in the method of producing an infrared light-reflecting film of the invention will be sequentially described. First, each of the production steps that are preferably used in the invention will be described.

Coating Step:

The production method of the invention includes a coating step of coating a polymerizable liquid crystal composition including a polymerizable cholesteric liquid crystal compound (A), a chiral agent having an HTP represented by the following Expression (1) of 50 μm⁻¹ or less (B), a monofunctional monomer (C), and an organic solvent (D) on a substrate.

HTP=Refractive Index of Polymerizable Cholesteric Liquid Crystal Compound/{Selective Reflection Wavelength (unit: μm) of Cholesteric Liquid Crystal Phase×Mass ratio of Chiral Agent to Polymerizable Cholesteric Liquid Crystal Compound} Expression (1)

The polymerizable liquid crystal composition is preferably prepared by dissolving and/or dispersing the materials into the organic solvent (D). In the production method of the invention, it is preferable that a photopolymerization initiator be added to the polymerizable liquid crystal composition.

In the coating step of the invention, the polymerizable liquid crystal composition is finished into a coating liquid, and is preferably coated on a surface of a substrate such as polymer film, a glass plate, a quartz plate, and the like, or, if necessary, to a surface of an alignment layer formed on the substrate. The polymerizable liquid crystal composition can be coated according to various methods of a wire bar coating method, an extrusion coating method, a direct gravure coating method, a reverse gravure coating method, a die coating method, and the like.

Drying Step:

The production method of the invention may further include a drying step of drying the coated polymerizable liquid crystal composition, in addition to the coating step, the alignment step, and the irradiation step. The drying step may be carried out at any time, or preferably carried out after the coating step, and more preferably after the coating step and before the alignment step. Further, the drying step can be carried out without limitation by heating, blowing air, or other methods, but it is preferably carried out by heating at 10° C. to 60° C. for 5 seconds to 600 seconds, more preferably at 15° C. to 55° C. for 5 seconds to 200 seconds, particularly preferably at 20° C. to 50° C. for 10 seconds to 100 seconds.

The amount of the residual solvent after the drying step, that can be used in the invention, is preferably controlled to 0.25 g/m² or more and 1.5 g/m² or less, more preferably to 0.3 g/m² or more and 1.2 g/m² or less, and particularly preferably to 0.4 g/m² or more and 1.0 g/m² or less. The amount of the residual solvent after the drying step can be calculated in the following manner.

(Amount of Residual Solvent after Drying Step)=(Mass after Drying Step)−(Mass after Drying at 130° C./30 minutes)

In addition, as a method for controlling a range of the amount of the residual solvent after the drying step, a method such as a method for controlling the amount of the residual solvent after the alignment step as described below can be preferably used.

Alignment Step:

The production method of the invention includes a step in which the coated polymerizable liquid crystal composition is heated to align the polymerizable cholesteric liquid crystal compound to form a state of a cholesteric liquid crystal phase.

In order to set a transition temperature to form the cholesteric liquid crystal phase, the coated polymerizable liquid crystal composition is heated. As a heating method, for example, the coating film is once heated up to the temperature of the isotropic phase, and then cooled to the cholesteric liquid crystal phase transition temperature, whereby the film may stably have the intended cholesteric liquid crystal phase. The liquid crystal transition temperature of the curable liquid crystal composition is preferably within a range of from 10 to 250° C. from the viewpoint of the production aptitude, and more preferably within a range of from 10 to 150° C. With the temperature of 10° C. or higher, it is easy to adjust the temperature to a temperature range exhibiting the liquid crystal phase, whereas the temperature of 200° C. or lower is preferable from the viewpoints of consumption of heat energy or the like, and is advantageous in view of deformation, degradation, or the like of the substrate.

In order to align the polymerizable cholesteric liquid crystal compound to form a state of a cholesteric liquid crystal phase, it is preferable to heat the compound at 50° C. to 150° C. for 5 seconds to 600 seconds, more preferably at 70° C. to 130° C. for 5 seconds to 480 seconds, and particularly preferably at 80° C. to 100° C. for 30 seconds to 300 seconds.

In the invention, the amount of the residual solvent after the alignment step is controlled to 0.20 g/m² or more.

The amount of the residual solvent after the alignment step can be measured by means of an analysis balance XP205 (manufactured by METTLER TOLEDO International Inc.), and calculated by the following formula.

(Amount of Residual Solvent after Alignment Step)=(Mass after Alignment Step)−(Mass after Drying at 130° C./30 Minutes)

In addition, examples of the method for controlling a range of the amount of the residual solvent after the alignment step include use of the following types of organic solvents or a combination thereof.

The amount of the residual solvent after the alignment step of the invention is preferably controlled to 0.20 g/m² or more and 0.50 g/m² or less, more preferably 0.23 g/m² or more and 0.40 g/m² or less, and particularly preferably 0.26 g/m² or more and 0.33 g/m² or less.

The mechanism with which an infrared light-reflecting film having excellent brittleness and a good haze can be obtained by controlling the amount of the residual solvent after the alignment step in the invention to 0.20 g/m² or more even when a chiral agent having a low HTP and monofunctional monomer is used is not sufficiently clarified, but the present inventors have speculated as follows. Since the amount of the residual solvent in the liquid crystal film during the liquid crystal alignment step is large, the viscosity of the liquid crystal film is lowered and the liquid crystal in the liquid crystal film easily moves, and accordingly, is easily helically aligned. Further, the monofunctional monomer moves between the polymerizable liquid crystals and is polymerized, portions having broken network in places are generated, which have a rubber-like action. Thus, it is thought that the film is easily stretched and the brittleness is improved. It is thought that by the above action, the effect of the invention can be obtained. However, the invention is not limited to the mechanism above.

Irradiation Step:

The production method of the invention includes an irradiation step in which the polymerizable liquid crystal composition is irradiated with actinic radiation to fix the cholesteric liquid crystal phase and form an infrared light-reflecting layer.

As the actinic radiation, ultraviolet rays or the like can be used. When irradiation with ultraviolet rays is used, a light source such as an ultraviolet ray lamp and the like is used. In this step, by irradiation with ultraviolet rays, the cholesteric liquid crystal phase is fixed, and the infrared light-reflecting layer is formed.

The energy amount with irradiation of actinic radiation is not particularly limited, but is generally from about 100 mJ/cm² to 800 mJ/cm². Further, the time for irradiating the polymerizable liquid crystal composition with actinic radiation is not particularly limited, but is determined from the viewpoints of sufficient strength of a cured film (infrared light-reflecting layer) and productivity.

In order to promote the reaction for fixing the cholesteric liquid crystal phase, irradiation with actinic radiation under a heating condition may be carried out. Further, it is preferable to maintain the temperature during irradiation with actinic radiation to a temperature range showing the cholesteric liquid crystal phase and not so as to deform the cholesteric liquid crystal phase. In addition, the oxygen concentration under a curing reaction atmosphere is involved in the degree of polymerization. For this reason, a desired degree of polymerization is not attained with a curing reaction in air, and when the film strength is not sufficient, it is preferable to lower the oxygen concentration under the curing reaction atmosphere by a method such as nitrogen replacement and the like. As a desirable oxygen concentration, it is preferably 10% by volume or less, more preferably, more preferably 7% by volume or less, and most preferably 3% by volume or the less.

In the irradiation step, the cholesteric liquid crystal phase is fixed and an infrared light-reflecting layer is formed. Herein, the state in which the liquid crystal phase is “fixed” is most usually a state in which the alignment of the liquid crystal compound made of the cholesteric liquid crystal phase is maintained, and in a preferable embodiment, it is not limiting. Specifically, in a temperature range of usually 0° C. to 50° C., or under a more stringent condition of −30° C. to 70° C., the state means a state in which the fixed alignment morphology can be stably maintained while the infrared light-reflecting layer is not flowable and the alignment morphology is not caused to be changed by an external field or external force. In the invention, the alignment state of the cholesteric liquid crystal phase is fixed by irradiation with actinic radiation.

Further, in the invention, the optical properties of the cholesteric liquid crystal phase are sufficient as long as they are maintained in the infrared light-reflecting layer, and it is not necessary that the liquid crystal composition in the infrared light-reflecting layer exhibit a liquid crystal property consequently. For example, the liquid crystal composition may have a high molecular weight due to a curing reaction and thus lose the liquid crystal property.

Lamination Step:

The production method of the invention preferably includes a laminating step of laminating two or more (more preferably three or more) infrared light-reflecting layers by repeating at least once a set of the coating step using the other kind of the polymerizable liquid crystal composition on the infrared light-reflecting layer, the alignment step, and the irradiation step. The production method of the invention can also be preferably employed in the case of obtaining a laminate having three or more infrared light-reflecting layers above.

(Materials)

Next, the materials that can be used in the production method of the invention will be described. In the production method of the invention, the polymerizable cholesteric liquid crystal compound (A), the chiral agent having an HTP represented by the Expression (1) of 50 μm¹ or less (B), the monofunctional monomer (C), and the organic solvent (D) are used.

Furthermore, in the production method of the invention, an alignment control agent is preferably included from the viewpoint of obtaining a good alignment property. Further, in the production method of the invention, a polymerization initiator is preferably included.

Polymerizable Cholesteric Liquid Crystal Compound:

The polymerizable liquid crystal composition that is used in the method of the invention includes a polymerizable cholesteric liquid crystal compound.

The polymerizable cholesteric liquid crystal compound may be rod-shaped or disc-shaped, but it is preferably rod-shaped.

Examples of the rod-like polymerizable cholesteric liquid crystal compound that can be used in the invention include a nematic rod-like liquid crystal compound. Preferable examples of the nematic rod-like liquid crystal compound include azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyl dioxanes, tolans, and alkenylcyclohexyl benzonitriles. The rod-shaped polymerizable cholesteric liquid crystal compound may be either a low-molecular weight compound or a high-molecular weight compound.

In the production method of the invention, the polymerizable liquid crystal composition is one exhibiting a cholesteric liquid crystal phase, and the polymerizable liquid crystal composition includes at least one kind of polymerizable cholesteric liquid crystal compound.

The polymerizable cholesteric liquid crystal compound can be obtained by introducing a polymerizable group into the cholesteric liquid crystal compound. Examples of the polymerizable group include an unsaturated polymerizable group, an epoxy group, and an aziridinyl group, and an unsaturated polymerizable group is preferable; and an ethylene unsaturated polymerizable group is particularly preferable. The polymerizable group may be introduced into the molecule of the cholesteric liquid crystal compound according to any of various methods. The number of the polymerizable groups included in the polymerizable cholesteric liquid crystal compound is preferably from 1 to 6, and more preferably from 1 to 3. Examples of the polymerizable cholesteric liquid crystal compound include those described in Makromol. Chem., Vol. 190, p. 2255 (1989), Advanced Materials, vol. 5, p. 107 (1993), U.S. Pat. No. 4,683,327B, U.S. Pat. No. 5,622,648B, U.S. Pat. No. 5,770,107B, WO95/22586, WO95/24455, WO97/00600, WO98/23580, WO98/52905, JP1989-272551A (JP-H1-272551A), JP1994-16616A (JP-H6-16616A), JP1995-110469A (JP-H7-110469A), JP1999-80081A (JP-H11-80081A), JP2001-328973A, and the like. The polymerizable cholesteric liquid crystal compound may be used singly or in combination of two or more kinds thereof. When the rod-like polymerizable liquid crystal compounds are used in combination of two or more kinds thereof, the alignment temperature may be lowered.

Moreover, the addition amount of the polymerizable cholesteric liquid crystal compound with respect to the total mass of the polymerizable cholesteric liquid crystal compound (A) and the monofunctional monomer (C) in the polymerizable liquid crystal composition is preferably from 50 to 99% by mass, more preferably from 70 to 98% by mass, and particularly preferably from 80 to 95% by mass, based on the polymerizable liquid crystal composition.

Chiral Agent (Optically Active Compound):

The polymerizable liquid crystal composition is one exhibiting a cholesteric liquid crystal phase, and accordingly, it includes a chiral agent. In the invention, a chiral agent having an HTP of 50 μm⁻¹ or less is used. The chiral agent may be selected from any known chiral agents having an HTP of 50 μm⁻¹ or less. (for example, chiral agents used in TN and STN modes, described in Ekisho Debaisu Handobukku (Liquid Crystal Device Handbook), 3^{rd} Chapter, No. 4-3, p. 199, edited by No. 142 Committee of Japan Society for the Promotion of Science, published by the Nikkan Kogyo Shimbun, Ltd., in 1989. In the invention, a chiral agent having an HTP of 45 μm⁻¹ or less is particularly preferably used, and a chiral agent having an HTP of 40 μm⁻¹ or lower is further more preferably used.

Although, an optically-active compound generally has a chiral carbon in its molecule, axially chiral compounds and planar chiral compound, having no chiral carbon, may be used as a chiral compound in the invention. Examples of the axially chiral compound or the planar chiral compound include binaphthyl, helicene, paracyclophane and derivatives thereof. The chiral agent may have a polymerizable group. When the chiral agent has a polymerizable group, it is possible to form a polymer having repeating units derived from a cholesteric liquid crystal compound from the polymerization reaction of the polymerizable chiral agent and the polymerizable cholesteric liquid crystal compound. In this embodiment, the polymerizable group included in the polymerizable chiral agent is preferably the same group as the polymerizable group included in the polymerizable cholesteric liquid crystal compound. Accordingly, it is preferably a polymerizable group contained in the chiral agent, an unsaturated polymerizable group, an epoxy group, or an aziridinyl group, more preferably an unsaturated polymerizable group, and particularly preferably an ethylenically unsaturated polymerizable group.

Further, the chiral agent may be a liquid crystal compound.

The content of the chiral agent in the polymerizable liquid crystal composition is preferably from 1 to 10% by mass with respect to the polymerizable cholesteric liquid crystal compound used in combination therewith. Further, the content of the chiral agent in the polymerizable liquid crystal composition is more preferably from 1 to 24% by mass, and particularly preferably from 1 to 18% by mass, with respect to the polymerizable liquid crystal compound. In addition, the addition of the chiral agent in the polymerizable liquid crystal composition is preferably from 1 to 18% by mass, more preferably from 1 to 12% by mass, and particularly preferably from 1 to 7.8% by mass, with respect to the total mass of the polymerizable cholesteric liquid crystal compound (A) and the monofunctional monomer (C) in the polymerizable liquid crystal composition.

Monofunctional Monomers:

The polymerizable liquid crystal composition used in the invention includes a monofunctional monomer in order to increase the brittleness of the infrared light-reflecting film. In the present specification, the monofunctional monomer refers to a compound having one polymerizable group. The monofunctional monomer that is used in the invention is not limited as long as it is a compound having one polymerizable group. The monofunctional monomers may be used singly or in combination of two or more kinds thereof, if desired.

Hereinafter, specific examples of the monofunctional monomer that can be used in the invention are shown below, but the invention is not limited to such specific examples. Further, the monofunctional monomer that can be used in the invention preferably has a structure of a (meth)acrylate among the following specific examples, and more preferably has a structure of a monofunctional alkyl (meth)acrylate.

### <<Compound Examples of (Meth)Acrylates>>

In the invention, the “(meth)acrylate” refers to an acrylate or a methacrylate. Further, the “(meth)acryloyloxy” means acryloyloxy or methacryloyloxy.

(Examples of Monofunctional Alkyl (Meth)Acrylates)

Methyl (meth)acrylate, ethyl (meth)acrylate, propyl (meth)acrylate, isopropyl (meth)acrylate, butyl (meth)acrylate, isoamyl (meth)acrylate, hexyl (meth)acrylate, 2-ethylhexyl (meth)acrylate, octyl (meth)acrylate, decyl (meth)acrylate, lauryl (meth)acrylate, stearyl (meth)acrylate, isobornyl (meth)acrylate, cyclohexyl (meth)acrylate, dicyclopentenyl (meth)acrylate, dicyclopentenyloxyethyl (meth)acrylate, and benzyl (meth)acrylate.

(Examples of Monofunctional Hydroxy-Containing (Meth)Acrylates)

2-Hydroxyethyl (meth)acrylate, 2-hydroxypropyl (meth)acrylate, 2-hydroxy-3-chloropropyl (meth)acrylate, 2-hydroxy-3-phenoxypropyl (meth)acrylate, 2-hydroxy-3-allyloxypropyl (meth)acrylate, and 2-(meth)acryloyloxyethyl-2-hydroxypropylphthalate.

(Examples of Monofunctional Halogen-Containing (Meth)Acrylates)

2,2,2-Trifluoroethyl (meth)acrylate, 2,2,3,3-tetrafluoropropyl (meth)acrylate, 1H-hexafluoroisopropyl (meth)acrylate, 1H,1H,5H-octafluoropentyl (meth)acrylate, 1H,1H,2H,2H-heptadecafluorodecyl (meth)acrylate, 2,6-dibromo-4-butylphenyl (meth)acrylate, 2,4,6-tribromophenoxyethyl (meth)acrylate, and 2,4,6-tribromophenol-3EO-added (meth)acrylate.

(Examples of Monofunctional Ether Group-Containing (Meth)Acrylates)

2-Methoxyethyl (meth)acrylate, 1,3-butylene glycol methyl ether (meth)acrylate, butoxyethyl (meth)acrylate, methoxytriethylene glycol (meth)acrylate, methoxypolyethylene glycol #400(meth)acrylate, methoxydipropylene glycol (meth)acrylate, methoxytripropylene glycol (meth)acrylate, methoxypolypropylene glycol (meth)acrylate, ethoxydiethylene glycol (meth)acrylate, 2-ethylhexylcarbitol (meth)acrylate, tetrahydrofurfuryl (meth)acrylate, phenoxyethyl (meth)acrylate, phenoxydiethylene glycol (meth)acrylate, phenoxypolyethylene glycol (meth)acrylate, cresylpolyethylene glycol (meth)acrylate, p-nonylphenoxyethyl (meth)acrylate, p-nonylphenoxypolyethylene glycol (meth)acrylate, and glycidyl (meth)acrylate.

(Examples of Monofunctional Carboxyl-Containing (Meth)Acrylates)

β-carboxyethyl (meth)acrylate, succinic acid mono(meth)acryloyloxyethylester, ω-carboxypolycaprolactone mono(meth)acrylate, 2-(meth)acryloyloxyethylhydrogen phthalate, 2-(meth)acryloyloxypropylhydrogen phthalate, 2-(meth)acryloyloxypropylhexahydrohydrogen phthalate, and 2-(meth)acryloyloxypropyltetrahydrohydrogen phthalate.

(Examples of Other Monofunctional (Meth)Acrylates)

N,N-Dimethylaminoethyl (meth)acrylate, N,N-dimethylaminopropyl (meth)acrylate, morpholinoethyl (meth)acrylate, trimethylsiloxyethyl (meth)acrylate, diphenyl-2-(meth)acryloyloxyethylphosphate, 2-(meth)acryloyloxyethyl acid phosphate, and caprolactone-modified-2-(meth)acryloyloxyethyl acid phosphate.

<<Compound Examples of Arylates>>

Allyl glycidyl ether, diallyl phthalate, triallyl trimellitate, and isocyanuric acid triarylate.

<<Compound Examples of Acid Amides>>

Acrylamide, N-methylol acrylamide, diacetone acrylamide, N,N-dimethylacrylamide, N,N-diethylacrylamide, N-isopropylacrylamide, acryloyl morpholine, methacrylamide, N-methylolmethacrylamide, diacetone methacrylamide, N,N-dimethylmethacrylamide, N,N-diethylmethacrylamide, N-isopropylmethacrylamide, and methacryloyl morpholine.

<<Compound Examples of Styrenes>>

Styrene, p-hydroxystyrene, p-chlorostyrene, p-bromostyrene, p-methylstyrene, p-methoxystyrene, p-t-butoxystyrene, p-t-butoxycarbonylstyrene, p-t-butoxycarbonyloxystyrene, 2,4-diphenyl-4-methyl-1-pentene.

<<Examples of Other Vinyl Compounds>>

Vinyl acetate, vinyl monochloroacetate, vinyl benzoate, vinyl pivalate, vinyl butyrate, vinyl laurate, divinyl adipate, vinyl methacrylate, vinyl crotonate, vinyl 2-ethyl hexanoate, N-vinylcarbazole, N-vinylpyrrolidone, and the like.

The addition amount of the monofunctional monomer in the polymerizable liquid crystal composition is preferably from 1.8 to 30% by mass, more preferably from 2 to 30% by mass, even more preferably from 2 to 27% by mass, particularly preferably from 2.7 to 20% by mass, and most preferably from 4.5 to 9% by mass, with respect to the total amount of the polymerizable cholesteric liquid crystal compound (A) and the monofunctional monomer (C) in the polymerizable liquid crystal composition.

Organic Solvent:

The organic solvent in which the polymerizable cholesteric liquid crystal compound is dissolved is not particularly limited, but known solvents may be used. Examples thereof include mentioned ketones (acetone, 2-butanone, methyl isobutyl ketone, cyclohexanone, and the like); ethers (dioxane, tetrahydrofuran, and the like); aliphatic hydrocarbons (hexane, and the like); alicyclic hydrocarbons (cyclohexane, and the like); aromatic hydrocarbons (toluene, xylene, trimethylbenzene, and the like); halogenohydrocarbons (dichloromethane, dichloroethane, dichlorobenzene, chlorotoluene, and the like); esters (methyl acetate, ethyl acetate, butyl acetate, and the like); water; alcohols (ethanol, isopropanol, butanol, cyclohexanol, and the like); cellosolves (methyl cellosolve, ethyl cellosolve, and the like); cellosolve acetates; sulfoxides (dimethyl sulfoxide, and the like); amides (dimethylformamide, dimethylacetamide, and the like); etc.

In the production method of the invention, one kind or two or more kinds of organic solvent can be used, and two or more kinds of organic solvent are preferably used.

Furthermore, from the viewpoints of the solubility of the solid contents and the efficiency of drying the coated film, an organic solvent having a boiling point under standard conditions (normal temperature (25° C.) and normal pressure) of 150° C. or higher is preferably used, an organic solvent having a boiling point of 150° C. or higher and 200° C. or lower is more preferably used, and an organic solvent having a boiling point of 150° C. or higher and 190° C. or lower is particularly preferably used. In addition, an organic solvent having a boiling point of 150° C. or higher is preferably added in an amount of 2% by mass to 30% by mass, more preferably in an amount of 4% by mass to 20% by mass, and particularly preferably in an amount of 5% by mass to 10% by mass, with respect to the total amount of the organic solvent. Herein, it is generally thought that the amount of the eluate eluting from the coated film is increased by increasing the amount of the residual solvent after the alignment step, and thus, if the amount of water in the solvent is increased, the alignment of the liquid crystal is deteriorated. As a result, adjustment of the amount of the residual solvent to a high value of 0.20 g/m² or more as in the invention cannot be usually employed in the case of forming a film by coating a liquid crystal layer. Particularly, it is thought that since in the case where two or more layers, and preferably three or more layers, for the purpose of extending the reflection wavelength band, of the coated film of the polymerizable liquid crystal composition are laminated in order to reflect left-handed circular polarization and right-handed circular polarization at once as in a preferable embodiment of the invention, the eluate is generated at each coating step, and as a result, a risk of the increase in the amount of the eluate is increased when the residual solvent is increased. Therefore, adjusting the amount of the residual solvent to a high value of 0.20 g/m² or more as in the invention even in the case of producing a film with one layer of the liquid crystal layer has not been substantially investigated. Particularly, it has been thought that it is not necessary to conduct an investigation in an optically reflective film using a cholesteric liquid crystal phase which is required to reflect left-handed circular polarization and right-handed circular polarization at once or to extend a narrow reflection wavelength band. Contrary to these findings, in the invention, the alignment of the liquid crystal is improved and the haze can be further improved even when a chiral agent having a low HTP is used as a polymerizable liquid crystal composition component and a monofunctional monomer for improving the brittleness is added by increasing the amount of the residual solvent of the organic solvent (D) after the alignment step in the polymerizable liquid crystal composition. Particularly, this effect is apparent when an organic solvent having a boiling point of 150° C. or higher is at least included as an organic solvent (D) in the polymerizable liquid crystal composition. The reason therefor is not clear and not restricted to any theory, but the present inventors have speculated as follows. It is thought that when a coating liquid of a polymerizable liquid crystal composition for an upper layer containing a large amount of a solvent is coated on a lower layer that is an infrared light-reflecting layer, the polymerizable liquid crystal composition for an upper layer cannot easily dissolve the lower layer by a mechanism described in the alignment step or the like in the present specification, and thus, the effect of the invention is enhanced. Among these, in a more preferable embodiment of the invention, by adding an organic solvent having a specific structure as described later, an organic solvent having a high boiling point, in which the boiling point is within a specific range, or the like to the polymerizable liquid crystal composition, there is a further effect on an SP value or the like, and thus, the effect of the invention is further enhanced. The organic solvent having a boiling point of 150° C. or higher, that is used in the invention, is preferably a compound having a hydrocarbon ring in the form of a 6- to 7-membered ring. The hydrocarbon ring may further have a substituent and examples of the substituent include a quinone group (═O), a hydroxyl group, an alkyl group (preferably having 1 to 3 carbon atoms), a halogen atom (preferably a chlorine atom), and the like. Among the hydrocarbon rings of a 6- to 7-membered ring, specifically, preferable examples include cyclohexanone, cyclohexanol, dichlorobenzene, trimethylbenzene, chlorotoluene, and the like. In addition, the organic solvent that is used in the invention is more preferably a compound having a hydrocarbon ring of a 6-membered ring, and particularly preferably cyclohexanone or cyclohexanol. From the viewpoints of a coating film-forming property, production efficiency, or the like, the addition amount of the organic solvent in the polymerizable liquid crystal composition is preferably from 50% by mass to 80% by mass, and more preferably from 40% by mass to 70% by mass.

Alignment-Control Agent:

Preferable examples of the alignment control agent that can be used in the invention include compounds represented by the following general formulae (I) to (IV). Two or more kinds selected from these compounds may be used in combination. The compounds may contribute to aligning the molecules of the cholesteric liquid crystal compound with a reduced tilt angle or substantially horizontally at the air-interface alignment of the infrared light-reflecting layer.

Further, it is to be understood that the term “horizontal alignment” in the present specification means that the direction of long axis of a liquid crystalline molecule is parallel to the layer plane, wherein being strictly parallel is not always necessary; and means, in this specification, that a tilt angle of the mean direction of long axes of the liquid crystalline molecules with respect to the horizontal plane is smaller than 20°. The layer in which liquid crystal molecules are horizontally aligned at the air-interface may hardly suffer from alignment defects, and may have a high transparency for visible light and have a high reflectacne. On the other hand, the layer in which the liquid crystal molecules are aligned with a large tilt angle may suffer from the finger-print pattern, and may have a low reflectacne, a high haze, and diffraction characteristics, because of the misalignment between the helical axis of the cholesteric liquid crystal phase and the normal line of the layer surface.

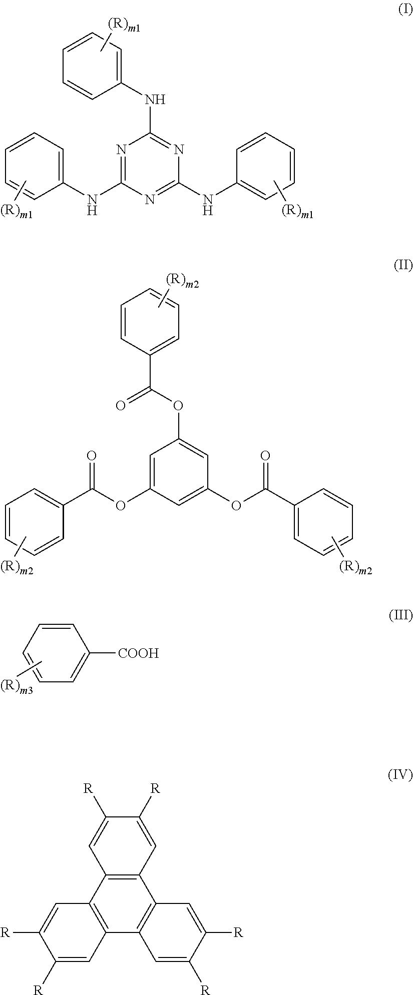

In the formulae, a plurality of R's are the same as or different from each other and represent an alkoxy group having 1 to 30 carbon atoms, preferably 1 to 20 carbon atoms, and more preferably 1 to 15 carbon atoms, which may be substituted with a fluorine atom. One or more CH₂ or two or more CH₂, which are not adjacent to each other, in the alkoxy group may be substituted with O, S, OCO—, —COO—, —NR^{a}—, —NR^{a}CO—, —CONR^{a}—, —NR^{a}SO₂—, or —SO₂NR^{a}—. R^{a} represents a hydrogen atom or an alkyl group having 1 to 5 carbon atoms. By substituting R with one or more fluorine atoms, the alignment control agents are highly distributed and localized at the air-interface of the light-reflecting layer, and elute and diffuse into the upper layer easily. The compound having a terminal carbon atom substituted with a fluorine atom is preferable; and the compound having a perfluoroalkyl group at the terminal is more preferable.

Examples of “R” include the following functional groups.
—OCₙH₂ₙ₊₁
—(OC₂H₄)ₙ₁(CF₂)ₙ₂F
—(IC₃H₆)ₙ₁(CF₂)ₙ₂F
—(IC₂H₄)ₙ₁NR^{a}SO₂(CF₂)ₙ₂F
—(OC₃H₆)ₙ₁NR^{a}SO₂(CF₂)ₙ₂F

In the formulae, n, n1, and n2 represent an integer of equal to or more than 1, respectively; n is preferably from 1 to 20, or more preferably from 5 to 15; n1 is preferably from 1 to 10, or more preferably from 1 to 5; and n2 is preferably from 1 to 10, or more preferably from 2 to 10.

In the formulae, m1, m2, and m3 represent an integer of equal to or more than 1 respectively.

In the formula, m1 is preferably 1 or 2, or more preferably 2. When m1 is 1, it preferably links to the para-position; and when m1 is 2, R's preferably link to the para- and meta-positions.

In the formula, m2 is preferably 1 or 2, or more preferably 1. When m1 is 1, it preferably links to the para-position; and when m1 is 2, R's preferably link to the para- and meta-positions.

In the formula, m3 is preferably from 1 to 3; and R's preferably links to two meta-positions and one para-position with respect to the position of —COOH.

Examples of the compound represented by the formula (I) include those described in paragraphs [0092]-[0093] of JP2005-99248A.

Examples of the compound represented by the formula (II) include those described in paragraphs [0076]-[0078] and paragraphs [0082]-[0085] of JP2002-129162A.

Examples of the compound represented by the formula (III) include those described in paragraphs [0094]-[0095] of JP2005-99248A.

Examples of the compound represented by the formula (IV) include those described in paragraph [0096] of JP2005-99248A.

The amount of the alignment control agent to be used is preferably from 0.01 to 20% by mass, and more preferably from 0.02 to 8% by mass, with respect to the polymerizable cholesteric liquid crystal compound (solid contents in the case of the coating liquid).

Polymerization Initiator:

The polymerizable liquid crystal composition preferably contains a polymerization initiator. In an embodiment in which a polymerization reaction proceeds by irradiation with ultraviolet rays, the polymerization initiator used is preferably a photopolymerization initiator capable of initiating a polymerization reaction by irradiation with ultraviolet rays. Examples of the photopolymerization initiator include α-carbonyl compounds (U.S. Pat. No. 2,367,661B and U.S. Pat. No. 2,367,670B), acyloin ethers (U.S. Pat. No. 2,448,828B), α-hydrocarbon-substituted aromatic acyloin compounds (U.S. Pat. No. 2,722,512B), polyneclear quinone compounds (U.S. Pat. No. 3,046,127B) and U.S. Pat. No. 2,951,758B), combinations of triarylimidazole dimer and p-aminophenyl ketone (U.S. Pat. No. 3,549,367B), acridine and phenazine compounds (JP1985-105667A (JP-S60-105667A) and U.S. Pat. No. 4,239,850B), oxadiazole compounds (U.S. Pat. No. 4,212,970B), and the like.

The content of the photopolymerization initiator used is preferably from 0.1 to 20% by mass, and more preferably from 1 to 8% by mass, with respect to the polymerizable cholesteric liquid crystal compound (the solid content in the case of the coating liquid).

Other Additives:

In addition, the liquid crystal composition may include at least one additive selected from various additives such as an anti-unevenness agent, an anti-repelling agent, a polymerizable monomer, and the like so as to improve the uniformity of alignment, the coating property, or the film strength. Further, if necessary, the liquid crystal composition may contain any polymerization inhibitor, an antioxidant, an ultraviolet absorber, a light-stabilization agent, a coloring material, fine particles of metal oxide, or the like in an amount unless the optical properties of the infrared light-reflecting layer are lowered.

(Substrate)

The substrate that is used in the method of producing an infrared light-reflecting film of the invention is not particularly limited. An infrared light-reflecting layer is formed on any substrate, and thus, the infrared light-reflecting film of the invention can be produced. As the substrate, for example, a polymer film, a glass plate, a quartz plate, and the like, and a polymer film having high transmission to visible light is preferably used.

Examples of the polymer film having high transmission to visible light include polymer films used for various optical films that are used as a member of display devices such as a liquid crystal display device and the like. As the polymer film for an optical film, polyester films such as polyethylene terephthalate (PET), polybutylene naphthalate, and polyethylene naphthalate (PEN) films, and the like; polycarbonate (PC) films; polymethylmethacrylate films; polyolefin films such as polyethylene and polypropylene films, and the like; polyimide films, triacetyl cellulose (TAC) films are preferable, polyethylene terephthalate films and triacetyl cellulose films are more preferable, and polyethylene terephthalate films are particularly preferable.

[Infrared Light-Reflecting Film]

The infrared light-reflecting film of the invention is produced by the method of producing an infrared light-reflecting film of the invention, wherein the film preferably reflects infrared light at a wavelength of 800 nm or more, and more preferably light in a wavelength region reflecting 30% or more of the incident light in the infrared light region at 800 nm to 2000 nm. Hereinbelow, the light-reflecting film of the invention will be described.

(Configuration)

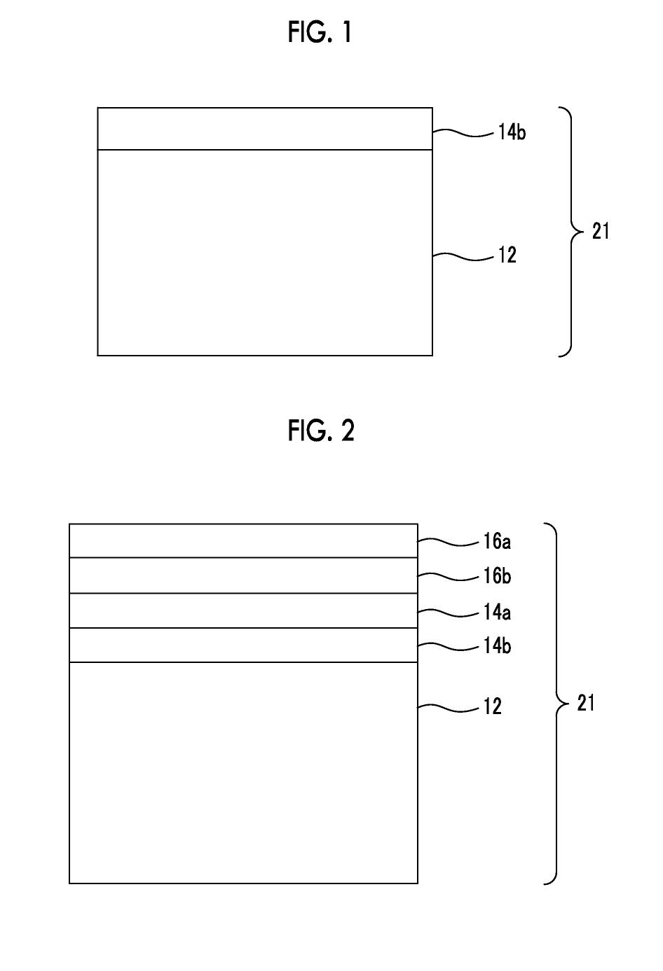

Examples of the infrared light-reflecting film produced through the use of the production method according to the invention are shown in FIGS. 1 and 2, respectively.

An infrared light-reflecting film 21 shown in FIG. 1 has an infrared light-reflecting layer 14b constituted by fixing a cholesteric liquid crystal phase on the surface on one side of a resin film 12. Further, infrared light-reflecting film 21 as shown in FIG. 2 further has infrared light-reflecting layers 14a, 16a, and 16b constituted by fixing a cholesteric liquid crystal phase thereon. The infrared light-reflecting film of the invention is not limited to such embodiments, and in a preferable embodiment, 3 or more infrared light-reflecting layers are formed, and in a more preferable embodiment, 6 or more infrared light-reflecting layers are formed.

In the infrared light-reflecting film 21 shown in FIGS. 1 and 2, respectively, the cholesteric liquid crystal-containing infrared light-reflecting layer immobilizes a cholesteric liquid crystal phase therein, and therefore, the infrared light-reflecting film 21 exhibits light selective reflection of reflecting a light having a specified wavelength on the basis of a helical pitch of the cholesteric liquid crystal phase. For example, when the adjacent light-reflecting layers (14a and 14b, or 16a and 16b) have a helical pitch of the same degree and exhibit an optical activity in a reverse direction to each other, any of left-handed and right-handed circular polarizations of a wavelength of the same degree can be reflected, and hence, such is preferable. For example, as an example of the infrared light-reflecting film 21 shown in FIG. 2, there is exemplified an example in which in the light-reflecting layers 14a and 14b, the light-reflecting layer 14a is composed of a liquid crystal composition containing a dextrorotatory chiral agent, whereas the light-reflecting layer 14b is composed of a liquid crystal composition containing a levorotatory chiral agent, and the light-reflecting layers 14a and 14b have a nearly-equal helical pitch.

In another example of the infrared light-reflecting film 21 shown in FIG. 2, the relationship between the infrared light-reflecting layers 14a and 14b are the same as in the above-mentioned example of the infrared light-reflecting film 21 (both helical pitches are d14 nm), the infrared light-reflecting layer 16a is formed of a curable liquid crystal composition containing a dextrorotatory chiral agent, the infrared light-reflecting layer 16b is formed of a curable liquid crystal composition containing a levorotatory chiral agent, the helical pitches in the infrared light-reflecting layers 16a and 16b are nearly equal (both helical pitches are d16 nm), and a condition d14≠d16 is satisfied. The infrared light-reflecting film 21 satisfying these conditions achieves the same advantages as the example of the infrared light-reflecting film 21 and the wavelength band of light to be reflected by the infrared light-reflecting layers 16a and 16b expands, thereby exhibiting a wide-band light-reflecting property. The invention is not limited to the even number of infrared light-reflecting layers, but an odd number of layers may be formed.

The infrared light-reflecting film produced through the use of the production method according to the invention exhibits a selective reflection characteristic based on the cholesteric liquid crystal phases of the respective layers. The infrared light-reflecting film according to the invention may have an infrared light-reflecting layer in which one of right-twisted and left-twisted cholesteric liquid crystal phases is fixed. When the infrared light-reflecting layers in which the right-twisted and left-twisted cholesteric liquid crystal phases of the same helical pitches are fixed are formed, the selective reflectance of light of a specific wavelength increases, which is preferable. When plural pairs of infrared light-reflecting layers in which the right-twisted and left-twisted cholesteric liquid crystal phases of the same helical pitches are fixed are formed, it is possible to raise the selective reflectance and to widen the selective reflection wavelength region, which is preferable. Incidentally, the rotation direction of the cholesteric liquid crystal phase can be adjusted by the use of the kinds of the rod-like liquid crystal compound or the kinds of the chiral agent to be added, and the helical pitch can be adjusted by the use of the concentrations of the materials.

(Characteristics)

The total thickness when the infrared light-reflecting film is a stacked body having two or more light-reflecting layers is not particularly limited. However, in the configuration in which the infrared light-reflecting film includes four or more infrared light-reflecting layers in which a cholesteric liquid crystal phase is fixed and exhibits the light-reflecting characteristic over the infrared light region, that is, in the configuration in which the infrared light-reflecting film exhibits the heat-shielding property, the thickness of each infrared light-reflecting layer is in the range of 3 to 6 μm and the total thickness of the light-reflecting film is generally in the range of 15 to 40 μm.

Moreover, the selective reflection wavelength of one infrared light-reflecting layer (each infrared light-reflecting layer in the case where the infrared light-reflecting film includes plural infrared light-reflecting layers) of the infrared light-reflecting film according to the invention is not particularly limited. By adjusting the helical pitch depending on its application, it is possible to give the reflection characteristic for light of a desired wavelength. For example, at least one infrared light-reflecting film can be provided which is a so-called infrared light-reflecting film reflecting a part of light in the infrared light wavelength region of 800 nm to 2000 nm. This infrared light-reflecting film exhibits the heat-shielding property. Another example of the infrared light-reflecting film according to the invention is an infrared light-reflecting film which can reflect 80% or more (more preferably 90% or more) of solar rays in the wavelength range of 900 nm to 1160 nm. When a window film is produced using this infrared light-reflecting film, it is possible to achieve high heat-shielding performance in which the shielding factor defined in JIS A-5759 (a film for a construction glass window) is 0.7 or less.

With the infrared light-reflecting film of the invention, a low haze can be attained, and specifically, the haze of the infrared light-reflecting film can be adjusted to less than 0.30%. The infrared light-reflecting film of the invention includes a chiral agent having an HTP represented by the following Expression (1) of 50 μm⁻¹ or less. Further, the haze of the infrared light-reflecting film is 0.50% or less, more preferably 0.40% or less, and particularly preferably 0.30% or less. In addition, it is preferable that the haze satisfy the preferred range as described above and the brittleness (elongation at break) as described later of the infrared light-reflecting film be 2% or more.

HTP=Refractive Index of Polymerizable Cholesteric Liquid Crystal Compound/{Selective Reflection Wavelength (unit: μm) of Cholesteric Liquid Crystal Phase×Mass ratio of Chiral Agent to Polymerizable Cholesteric Liquid Crystal Compound} Expression (1)

The infrared light-reflecting film that is used as attached onto windows or the like is required to be transparent, and a lower haze thereof is preferred. The haze is preferably 0.30% or less. Further, the haze is measured in accordance with JIS K 7136:2000 (method for determining the haze of a plastic-transparent material).

(Brittleness)

It is preferable that the haze of the infrared light-reflecting film of the invention have good brittleness. Particularly, when used in window members of vehicles or window members of building structures, it is preferable that the infrared light-reflecting film have good brittleness. The infrared light-reflecting film of the invention preferably has an elongation at break, as measured by the following method, of 2% or more, more preferably 4% or more, and particularly preferably 6% or more. The brittleness (elongation at break) in the invention can be determined by adding increasing load on a sample, measuring the growth at break, and calculating the elongation relative to the original length.

(Shape)

The infrared light-reflecting film according to the invention may have a sheet-like spread shape or a shape wound on a roll, and preferably has a shape wound on a roll. The infrared light-reflecting film according to the invention can maintain excellent optical characteristics even when the winding and the delivery are repeated in the production process, and can also maintain excellent optical characteristics even when it is stored or transported in the state where the produced light-reflecting film is wound on a roll.

The infrared light-reflecting film according to the invention may be a member having such a self-supporting property that it can be used as a window material or may be a member not having a self-supporting property but being bonded to a substrate such as a glass plate having a self-supporting property.

When the cholesteric liquid crystal phase is fixed, any one of a right-handed circular polarization component and a left-handed circular polarization component is fixed on one layer, and accordingly, the infrared light-reflecting film having one infrared light-reflecting layer exhibits 50% reflection performance to the maximum. By repeatedly laminating a layer reflecting the right-handed circularly-polarized light component and a layer reflecting the left-handed circularly-polarized light component, it is possible to enhance the reflection performance up to 100% to the maximum. The width of the reflection wavelength band is generally in the range of 100 to 150 nm, but the reflection wavelength band can be widened to the range of 150 to 300 nm by using a material having high birefringence Δn in the cholesteric liquid crystal phase or adjusting the chiral agent concentration distribution in the film section direction of the chiral agent in the produced infrared light-reflecting layer.

(Usage)

The usage of the infrared light-reflecting film of the invention is not particularly limited, but the infrared light-reflecting film is preferably used in window members of vehicles or window members of building structures.

The infrared light-reflecting film according to the invention may be used in the state where it is bonded to the surface of a glass plate or a plastic substrate. In this case, the bonding surface of the light-reflecting film to the glass plate or the like preferably has an adhesive property. In this embodiment, the infrared light-reflecting film according to the invention preferably has an adhesive layer or a highly-adhesive layer which can be bonded to the surface of a substrate such as a glass plate. The non-adhesive infrared light-reflecting film according to the invention not including an adhesive layer or a highly-adhesive layer may be bonded to the surface of a glass plate with an adhesive agent.

The infrared light-reflecting film according to the invention preferably exhibits the heat-shielding property with respect to solar rays and preferably efficiently reflects the infrared rays of 700 nm or greater in solar rays.

The infrared light-reflecting film according to the invention can be used as a heat-shielding window itself for a vehicle or a building or can be used as a sheet or film to be bonded to a window of a vehicle or a building. In addition, the film according to the invention can be used on a freezer showcase, as an agricultural house material, an agricultural reflecting sheet, and a solar cell film. Among those, the infrared light-reflecting film according to the invention can be preferably used as a window-attaching infrared light-reflecting film, in view of characteristics such as high transmittance of visible rays and a low haze.

Furthermore, the infrared light-reflecting film of the invention may be attached to the inside of reinforced glass and used as a member of a heating-shielding member.

The heat-shielding member is bonded as a solar ray shielding member to windows of buildings such as houses or office buildings or vehicles such as cars. Alternatively, the infrared light-reflecting film according to the invention can be used as a solar ray shielding member itself (for example, as a heat-shielding glass or a heat-shielding film).

### EXAMPLES

Hereinbelow, the features of the invention will be described in more detail with reference to Examples and Comparative Examples (where the comparative example is not a known technique). The materials, use amounts, ratios, process details, process sequences, and the like shown in Examples below may be appropriately modified without departing from the spirit of the invention. Accordingly, the scope of the invention should not be construed to be limited to the specific examples shown below.

The compounds that are used in Examples or Comparative Examples will be described below.

[Polymerizable Cholesteric Liquid Crystal Compound]

(Polymerizable Cholesteric Liquid Crystal Compound A-1)

Bifunctional Acrylate with Liquid Crystal Property
Trade name: RM-257
Source: Merck

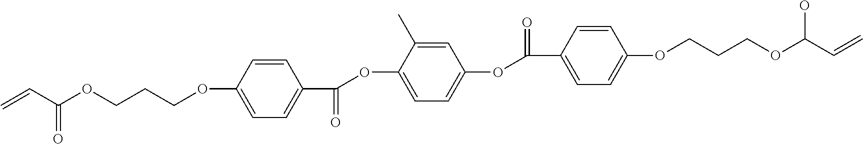

(Polymerizable Cholesteric Liquid Crystal Compound A-2)
Trade name: LC-1057
Source: BASF

(Chiral Agent B-3)
Structure:

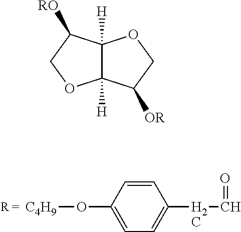

HTP:35, left-handed twisting

(Chiral Agent B-4)
Structure:

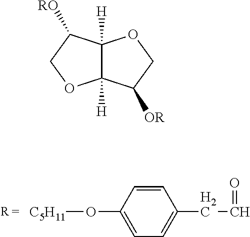

HTP:50, right-handed twisting

(Monofunctional Monomer C-1)
Structure:

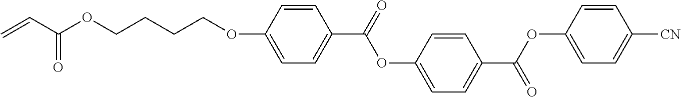

(Monofunctional Monomer C-2 without Liquid Crystal Property)
Benzyl acrylate
Trade name: VISCOAT #160
Source: manufactured by Osaka Organic Chemical Industry Ltd.

[Organic Solvent]
Cyclohexanone (manufactured by Osaka Organic Chemical Industry Ltd., boiling point under standard conditions of 155.6° C.)
Cyclohexanol (manufactured by Wako Pure Chemical Industries, Ltd., boiling point under standard conditions of 161° C.)
Paradichlorobenzene (manufactured by Wako Pure Chemical Industries, Ltd., boiling point under standard conditions of 174° C.)
1,3,5-trimethylbenzene (manufactured by Wako Pure Chemical Industries, Ltd., boiling point under standard conditions of 164° C.)
Parachlorotoluene (manufactured by Wako Pure Chemical Industries, Ltd., boiling point under standard conditions of 161. 99° C.)
Cyclopentanone (manufactured by Wako Pure Chemical Industries, Ltd., boiling point under standard conditions of 130° C.)
Pyridine (manufactured by Wako Pure Chemical Industries, Ltd., boiling point under standard conditions of 115° C.)
Methyl ethyl ketone (manufactured by Wako Pure Chemical Industries, Ltd., boiling point under standard conditions of 79.6° C.)

[Polymerization Initiator E]
Trade name: IRGACURE 819
Source: Ciba Specialty Chemicals, Ltd.

[Alignment Controlling Agent F]
Compound 1 (Compound described in JP2005-99248A)
Structure:

| 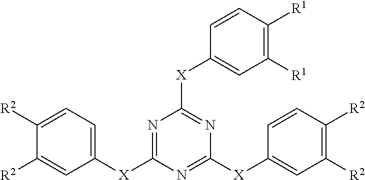 | | |
|---|---|---|
| R¹ | R² | X |
| O(CH₂)₂O(CH₂)₂(CF₂)₆F | O(CH₂)₂O(CH₂)₂(CF₂)₆F | NH |

### Example 1

### Preparation of Coating Liquid (Polymerizable Liquid Crystal Composition)

First, a coating liquid having the composition of Example 1 shown in Table 1 below was prepared.

(Coating, and Film Formation)

The prepared coating liquid was coated onto the surface of a PET film having a thickness of 50 μm, manufactured by FUJIFILM, at room temperature using a wire bar so as to have a thickness of the dried film of about 4 to 5 μm;

the film was dried at 30° C. for 30 seconds, and then heated in an atmosphere at 100° C. for 2 minutes to form a cholesteric liquid crystal phase; and

subsequently, controlling the output of the lamp using a metal halide lamp manufactured by Eye Graphics at 30° C., this was irradiated with UV rays in a nitrogen-purged atmosphere at a dose of 28.3 mW/cm² for 3 seconds to fix the cholesteric liquid crystal phase and to form an infrared light-reflecting film of Example 1. Further, the amount of the residual solvent after the drying step ((the amount of the residual solvent after the drying step)=(the mass after drying step)−(the mass after drying at 130° C. for 30 minutes)) was measured, and as a result, the amount of the residual solvent was 0.433 g/m². In addition, the amount of the residual solvent after the alignment step to give a cholesteric liquid crystal phase was measured in accordance with the method described in the present specification, and as a result, the amount of the residual solvent was 0.264 g/m².

### Examples 2 to 14 and Comparative Examples 1 to 4

In the same manner as in Example 1 except that the coating liquid was changed as shown in Table 1 below, infrared light-reflecting films of Examples and Comparative Examples were formed. Further, the addition amounts of the respective components in Table 1 below are based on mass.

(Haze of 7 Laminated Layers)

When the alignment of the cholesteric liquid crystal phase is deteriorated, the reflection rate is lower and the haze increases remarkably, and thus, as an index of the alignment property of the cholesteric liquid crystal phase, the total haze of the infrared light-reflecting film was measured. The haze was measured in accordance with JIS K 7136:2000 (method for determining the haze of plastic-transparent materials).
A: Haze of 0.20% or more and less than 0.30%
B: Haze of 0.30% or more and less than 0.40%
C: Haze of 0.40% or more and less than 0.50%
D: Haze of 0.50% or more and less than 0.70%
E: Haze of 0.70% or more

The infrared light-reflecting film rated C or higher can be practically used.

The obtained results are shown in Table 1 below.

Herein, the haze was measured in an embodiment in which seven infrared light-reflecting layers (cholesteric liquid crystal phase) were laminated on a resin film. Specifically, the first infrared light-reflecting layer was laminated on the resin film by the method above, and subsequently, 2 to 7 layers were laminated by the same method. Further, the types and the addition amounts of the polymerizable cholesteric liquid crystal compounds, the monofunctional monomers, and the chiral agents used in the first to seventh layer in the respective Examples and Comparative Examples were the same as each other, but the addition amount of the alignment control agent F in the first layer was adjusted to 0.03 parts by mass, whereas the addition amount of the alignment control agent F in the second or higher layer was adjusted to 0.01 parts by mass.

(Brittleness)

By a Tensilon tensile tester, tension was applied on a sample of 100 mm×10 mm (infrared light-reflecting film) while applying a load, and the elongation at break and the brittleness (elongation at break) were measured. The obtained results are shown in Table 1 with elongation at break (expressed as a percentage).

TABLE 1

| | | | | Ex. 1 | Ex. 2 | Ex. 3 | Ex. 4 | Ex. 5 | Ex. 6 | Ex. 7 |
|---|---|---|---|---|---|---|---|---|---|---|
| Polymerizable | (A) | A-1 | | 95 | 95 | 95 | 95 | 95 | 95 | 95 |
| composition | Polymerizable | A-2 | | — | — | — | — | — | — | — |
| (coating | cholesteric | | | | | | | | | |
| liquid) used | liquid crystal | | | | | | | | | |
| in coating | compound | | | | | | | | | |
| step | (B) Chiral agent | B-3 | HTP 35 μm⁻¹ | 4.5 | 4.5 | 4.5 | 4.5 | 4.5 | 4.5 | 4.5 |
| | | B-4 | HTP 50 μm⁻¹ | — | — | — | — | — | — | — |
| | (C) | C-1 | Monofunctional | 5 | 5 | 5 | 5 | 5 | 5 | 5 |
| | Monofunctional | C-2 | Monofunctional | — | — | — | — | — | — | — |
| | monomer | | | | | | | | | |
| | (D) Organic | Cyclohexanone | Boiling point | 19 | 5.7 | 3.8 | — | — | — | — |
| | Solvent | | 155.6° C. | | | | | | | |
| | | Cyclohexanol | Boiling point | — | — | — | 19 | 9.6 | — | — |
| | | | 161° C. | | | | | | | |
| | | Paradichlorobenzene | Boiling point | — | — | — | — | — | 9.6 | — |
| | | | 174° C. | | | | | | | |
| | | 1,3,5- | Boiling point | — | — | — | — | — | — | 9.6 |
| | | Trimethylbenzene | 164° C. | | | | | | | |
| | | Parachlorotoluene | Boiling point | — | — | — | — | — | — | — |
| | | | 161.99° C. | | | | | | | |
| | | Cyclopentanone | Boiling point | — | — | — | — | — | — | — |
| | | | 130° C. | | | | | | | |
| | | Pyridine | Boiling point | — | — | — | — | — | — | — |
| | | | 115° C. | | | | | | | |
| | | Methylethyl | Boiling point | 172 | 185 | 187 | 172 | 181 | 181 | 181 |
| | | ketone | 79.6° C. | | | | | | | |
| | Polymerization initiator E | | | 4 | 4 | 4 | 4 | 4 | 4 | 4 |
| Alignment controlling agent F | | | | 1st | 1st | 1st | 1st | 1st | 1st | 1st |
| | | | | layer | layer | layer | layer | layer | layer | layer |
| | | | | 0.03 | 0.03 | 0.03 | 0.03 | 0.03 | 0.03 | 0.03 |
| | | | | 2nd to | 2nd to | 2nd to | 2nd to | 2nd to | 2nd to | 2nd to |
| | | | | 7th | 7th | 7th | 7th | 7th | 7th | 7th |
| | | | | layers | layers | layers | layers | layers | layers | layers |
| | | | | 0.01 | 0.01 | 0.01 | 0.01 | 0.01 | 0.01 | 0.01 |
| (D) Ratio of the solvent having a boiling | | | | 10 | 3 | 2 | 10 | 5 | 5 | 5 |
| point of 150° C. or higher based on the | | | | | | | | | | |
| total amount of the organic solvent (% by mass) | | | | | | | | | | |
| Amount of the residual solvent after the | | | | 0.264 | 0.237 | 0.214 | 0.321 | 0.268 | 0.25 | 0.211 |
| alignment step (g/m²) | | | | | | | | | | |
| Haze of infrared light-reflecting film | | | | A | B | C | A | A | B | B |
| Brittleness of infrared light-reflecting | | | | 7% | 7% | 7% | 7% | 7% | 7% | 7% |
| film (elongation at break) | | | | | | | | | | |
| | | | | Ex. 8 | Ex. 9 | Ex. 10 | Ex. 11 | Ex. 12 | Ex. 13 | Ex. 14 |
| Polymerizable | (A) | A-1 | | 95 | 95 | 95 | 95 | 95 | — | 95 |
| composition | Polymerizable | A-2 | | — | — | — | — | — | 95 | — |
| (coating | cholesteric | | | | | | | | | |
| liquid) used | liquid crystal | | | | | | | | | |
| in coating | compound | | | | | | | | | |
| step | (B) Chiral agent | B-3 | HTP 35 μm⁻¹ | 4.5 | 4.5 | 4.5 | 4.5 | — | 4.5 | 4.5 |
| | | B-4 | HTP 50 μm⁻¹ | — | — | — | — | 3.4 | — | — |
| | (C) | C-1 | Monofunctional | 5 | 5 | 5 | 5 | 5 | 5 | — |
| | Monofunctional | C-2 | Monofunctional | — | — | — | — | — | — | 5 |
| | monomer | | | | | | | | | |
| | (D) Organic | Cyclohexanone | Boiling point | — | — | — | — | 19 | 19 | 19 |
| | Solvent | | 155.6° C. | | | | | | | |
| | | Cyclohexanol | Boiling point | — | — | — | — | — | — | — |
| | | | 161° C. | | | | | | | |
| | | Paradichlorobenzene | Boiling point | — | 19 | 29 | 38 | — | — | — |
| | | | 174° C. | | | | | | | |
| | | 1,3,5- | Boiling point | | | | | | | |
| | | Trimethylbenzene | 164° C. | | | | | | | |
| | | Parachlorotoluene | Boiling point | 9.6 | | | | | | |
| | | | 161.99° C. | | | | | | | |
| | | Cyclopentanone | Boiling point | — | — | — | — | — | — | — |
| | | | 130° C. | | | | | | | |
| | | Pyridine | Boiling point | — | — | — | — | — | — | — |
| | | | 115° C. | | | | | | | |
| | | Methylethyl | Boiling point | 181 | 172 | 162 | 153 | 172 | 172 | 172 |
| | | ketone | 79.6° C. | | | | | | | |

| | | | | | | | |
|---|---|---|---|---|---|---|---|
| Polymerization initiator E | 4 | 4 | 4 | 4 | 4 | 4 | 4 |

| | | | | | | | |
|---|---|---|---|---|---|---|---|
| Alignment controlling agent F | 1st | 1st | 1st | 1st | 1st | 1st | 1st |
| | layer | layer | layer | layer | layer | layer | layer |
| | 0.03 | 0.03 | 0.03 | 0.03 | 0.03 | 0.03 | 0.03 |
| | 2nd to | 2nd to | 2nd to | 2nd to | 2nd to | 2nd | 2nd |
| | 7th | 7th | 7th | 7th | 7th | to 7th | to 7th |
| | layers | layers | layers | layers | layers | layers | layers |
| | 0.01 | 0.01 | 0.01 | 0.01 | 0.01 | 0.01 | 0.01 |
| (D) Ratio of the solvent having a boiling | 5 | 10 | 15 | 20 | 10 | 10 | 10 |
| point of 150° C. or higher based on the | | | | | | | |
| total amount of the organic solvent (% by mass) | | | | | | | |
| Amount of the residual solvent after the | 0.25 | 0.35 | 0.40 | 0.50 | 0.264 | 0.264 | 0.264 |
| alignment step (g/m²) | | | | | | | |
| Haze of infrared light-reflecting film | B | A | B | B | A | A | A |
| Brittleness of infrared light-reflecting | 7% | 7% | 7% | 7% | 7% | 7% | 5% |
| film (elongation at break) | | | | | | | |

| | | | | Comp. | Comp. | Comp. | Comp. |
|---|---|---|---|---|---|---|---|
| | | | | Ex. 1 | Ex. 2 | Ex. 3 | Ex. 4 |
| Polymerizable | (A) | A-1 | | 95 | 95 | 95 | 95 |
| composition | Polymerizable | A-2 | | — | — | — | — |
| (coating | cholesteric | | | | | | |
| liquid) used | liquid crystal | | | | | | |
| in coating | compound | | | | | | |
| step | (B) Chiral agent | B-3 | HTP 35 μm⁻¹ | 4.5 | 4.5 | 4.5 | 4.5 |
| | | B-4 | HTP 50 μm⁻¹ | — | — | — | — |
| | (C) | C-1 | Monofunctional | 5 | 5 | 5 | |
| | Monofunctional | C-2 | Monofunctional | — | — | — | — |
| | monomer | | | | | | |
| | (D) Organic | Cyclohexanone | Boiling point | — | — | — | — |
| | Solvent | | 155.6° C. | | | | |
| | | Cyclohexanol | Boiling point | — | — | — | — |
| | | | 161° C. | | | | |
| | | Paradichlorobenzene | Boiling point | — | — | — | — |
| | | | 174° C. | | | | |
| | | 1,3,5- | Boiling point | | | | |
| | | Trimethylbenzene | 164° C. | | | | |
| | | Parachlorotoluene | Boiling point | | | | |
| | | | 161.99° C. | | | | |
| | | Cyclopentanone | Boiling point | 9.6 | — | — | — |
| | | | 130° C. | | | | |
| | | Pyridine | Boiling point | — | 9.6 | — | — |
| | | | 115° C. | | | | |
| | | Methylethyl | Boiling point | 181 | 181 | 181 | 191 |
| | | ketone | 79.6° C. | | | | |

| | | | | |
|---|---|---|---|---|
| Polymerization initiator E | 4 | 4 | 4 | 4 |

| | | | | |
|---|---|---|---|---|
| Alignment controlling agent F | 1st | 1st | 1st | 1st |
| | layer | layer | layer | layer |
| | 0.03 | 0.03 | 0.03 | 0.03 |
| | 2nd | 2nd to | 2nd to | 2nd to |
| | to 7th | 7th | 7th | 7th |
| | layers | layers | layers | layers |
| | 0.01 | 0.01 | 0.01 | 0.01 |
| (D) Ratio of the solvent having a boiling | 0 | 0 | 0 | 0 |
| point of 150° C. or higher based on the | | | | |
| total amount of the organic solvent (% by mass) | | | | |
| Amount of the residual solvent after the | 0.186 | 0.151 | 0.132 | 0.132 |
| alignment step (g/m²) | | | | |
| Haze of infrared light-reflecting film | D | D | E | B |
| Brittleness of infrared light-reflecting | 7% | 7% | 7% | 1% |
| film (elongation at break) | | | | |

From Table 1, it was found that by using the method of producing an infrared light-reflecting film of the invention, an infrared light-reflecting film having excellent brittleness as well as a low haze even when a chiral agent having a low HTP is used can be produced.

On the other hand, from Comparative Examples 1 to 3, it was found that when the amount of the residual solvent after the alignment step is below the range of the invention, the haze becomes higher.

In addition, the peak of the reflection wavelength of the infrared light-reflecting film obtained in each Example was 900 nm.

### Example 15

In the same manner as in Example 1 except that the number of the infrared light-reflecting layers was 3, an infrared light-reflecting film was produced. With respect to the obtained infrared light-reflecting film, the haze was measured by the same method as in Example 1. As a result, even when the number of the infrared light-reflecting layers was 3, an infrared light-reflecting film having the same alignment as in Example 1 was obtained.

### Example 16

In the same manner as above except that the infrared light-reflecting layer (also referred to as a first layer) laminated in Example 1 was cooled to room temperature, and then the chiral agent (B-3) for left-handed twisting used in Example 1 was changed to the chiral agent (B-4) for right-handed twisting as described below, a second layer was formed on the first layer of the infrared light-reflecting layers. Further, the peak of the reflection wavelength of the light-reflecting film after formation of the second layer was 1000 nm. In addition, in the same manner as in Example 1 except that the chiral agent (B-3) for left-handed twisting and the chiral agent (B-4) for right-handed twisting were used alternately on the second layer after adjusting to such a concentration that the peak of the reflection wavelength was 1120 nm, the third layer and the fourth layer were laminated. Subsequently, in the same manner, as in Example 1 except that the chiral agent (B-3) for left-handed twisting and the chiral agent (B-4) for right-handed twisting were used alternately thereon after adjusting to such a concentration that the peak of the reflection wavelength was 1240 nm, thereby forming a fifth layer and a sixth layer.

The obtained light-reflecting film has the same tendency as in Example 1.

Chiral Agent (B-4) for Right-Handed Twisting
HTP:55, right-handed twisting
Trade name: LC756
Source: BASF

What is claimed is:

1. A method of producing an infrared light-reflecting film, comprising:
a coating step of coating a polymerizable liquid crystal composition including a polymerizable cholesteric liquid crystal compound (A), a chiral agent having an HTP represented by the following Expression (1) of 50 μm⁻¹ or less (B), a monofunctional monomer (C), and an organic solvent (D) on a substrate,
an alignment step of aligning the polymerizable cholesteric liquid crystal compound by heating to form a cholesteric liquid crystal phase, and
an irradiation step of irradiating the polymerizable liquid crystal composition with actinic radiation to fix the cholesteric liquid crystal phase and form an infrared light-reflecting layer, wherein the amount of a residual solvent after the alignment step is controlled to 0.20 g/m² or more,
HTP=Refractive Index of Polymerizable Cholesteric Liquid Crystal Compound/{Selective Reflection Wavelength (unit: μm) of Cholesteric Liquid Crystal Phase×Mass ratio of Chiral Agent to Polymerizable Cholesteric Liquid Crystal Compound}. Expression (1)

2. The method of producing an infrared light-reflecting film according to claim 1, wherein the organic solvent (D) includes at least two kinds of organic solvent.

3. The method of producing an infrared light-reflecting film according to claim 1, wherein the organic solvent (D) includes an organic solvent having a boiling point of 150° C. or higher.

4. The method of producing an infrared light-reflecting film according to claim 3, wherein the proportion of the organic solvent having a boiling point of 150° C. or higher with respect to the total amount of the organic solvent (D) is not less than 3% by mass and not more than 30% by mass.

5. The method of producing an infrared light-reflecting film according to claim 3, wherein the organic solvent (D) is a compound having a hydrocarbon ring of a 6- to 7-membered ring.

6. The method of producing an infrared light-reflecting film according to claim 1, wherein the monofunctional monomer (C) is a (meth)acrylate compound.

7. The method of producing an infrared light-reflecting film according to claim 1, wherein the addition amount of the monofunctional monomer (C) with respect to the total mass of the polymerizable cholesteric liquid crystal compound (A) and the monofunctional monomer (C) in the polymerizable liquid crystal composition is from 2% by mass to 30% by mass.

8. The method of producing an infrared light-reflecting film according to claim 1, wherein the addition amount of chiral agent (B) with respect to the total mass of the polymerizable cholesteric liquid crystal compound (A) and the monofunctional monomer (C) in the polymerizable liquid crystal composition is from 1% by mass to 18% by mass.

9. The method of producing an infrared light-reflecting film according to claim 1, wherein the HTP of the chiral agent (B) is 40 μm⁻¹ or less.

10. The method of producing an infrared light-reflecting film according to claim 1, wherein a photopolymerization initiator is added to the polymerizable liquid crystal composition.

11. The method of producing an infrared light-reflecting film according to claim 1, wherein the infrared light-reflecting layer reflects infrared light at a wavelength of 800 nm or more.

12. The method of producing an infrared light-reflecting film according to claim 1, wherein the infrared light-reflecting layer reflects left-handed circularly polarized light.

13. The method of producing an infrared light-reflecting film according to claim 1, further comprising:
a laminating step of laminating two or more infrared light-reflecting layers by repeating at least once a set of the coating step using the other kind of the polymerizable liquid crystal composition on the infrared light-reflecting layer, the alignment step, and the irradiation step.

14. The method of producing an infrared light-reflecting film according to claim 13, wherein the infrared light-reflecting layer has at least one layer of each of a layer reflecting right-handed circularly polarized light and a layer reflecting left-handed circularly polarized light.

15. The method of producing an infrared light-reflecting film according to claim 13, wherein at least one of the infrared light-reflecting layers reflects infrared light at a wavelength of 800 nm or more.

16. The method of producing an infrared light-reflecting film according to claim 1, wherein the substrate is a polyethylene terephthalate film.

17. The method of producing an infrared light-reflecting film according to claim 1 for producing an infrared light-reflecting film for a window member of a vehicle or a window member of a building structure.

18. An infrared light-reflecting film produced by the method of producing an infrared light-reflecting film according to claim 1.
